(19) United States
(12) Patent Application Publication
(10) Pub. No.: US 2019/0130198 A1
(43) Pub. Date: May 2, 2019

(54) TRAVELING CONTROL DEVICE

(71) Applicant: TOYOTA JIDOSHA KABUSHIKI KAISHA, Toyota-shi (JP)

(72) Inventor: Yusuke HAYASHI, Susono-shi (JP)

(73) Assignee: TOYOTA JIDOSHA KABUSHIKI KAISHA, Toyota-shi (JP)

(21) Appl. No.: 16/139,200

(22) Filed: Sep. 24, 2018

(30) Foreign Application Priority Data
Oct. 26, 2017 (JP) 2017-207254

(51) Int. Cl. G06K 9/00; G05D 1/02; B60W 30/165; B60W 30/095; G05D 1/00

(52) U.S. Cl. CPC G06K 9/00825; G05D 1/0246; B60W 40/04; B60W 30/0956; G05D 1/0088; B60W 30/165

(57) ABSTRACT

A traveling control device includes a traffic signal detection unit configured to detect a traffic signal, a timing determination unit configured to determine whether or not a host vehicle has reached a transition signal determination timing, a lighting information acquisition unit configured to acquire lighting information, a lighting cycle information acquisition unit configured to acquire lighting cycle information of the traffic signal, a transition signal determination unit configured to determine whether or not a transition signal is lit in a traveling lane of the host vehicle based on the lighting information at the transition signal determination timing and the lighting cycle information, a smooth stop possibility determination unit configured to determine whether or not the host vehicle can be smoothly stopped when the transition signal is lit, and a traveling control unit configured to smoothly stop the host vehicle when the host vehicle can be smoothly stopped.

### CROSS-REFERENCE TO RELATED APPLICATION

This application claims the benefit of priority from Japanese Patent Application No. 2017-207254, filed Oct. 26, 2017, the entire contents of which are incorporated herein by reference.

### TECHNICAL FIELD

The present disclosure relates to a traveling control device.

### BACKGROUND

A device is known that executes traveling control of a host vehicle in accordance with the lighting situation of a traffic signal ahead based on a captured image of the space in front of the host vehicle. For instance, the device that is disclosed in U.S. Patent Application Publication No. 2014/0303829 assumes that a stop signal is lit in the traffic signal ahead and stops the host vehicle when a determination that a brake light of a preceding vehicle is lit is made based on the captured image.

### SUMMARY

Sometimes, tracking control for tracking the preceding vehicle is executed as the traveling control of the host vehicle. In this case, it is preferable that a decision on whether to pass through an intersection while tracking the preceding vehicle is made with the lighting situation of the traffic signal sufficiently taken into account when the host vehicle approaches the intersection that has the traffic signal while tracking the preceding vehicle. Especially, it is preferable that the lighting situation of the traffic signal is taken into account with regard to a transition signal indicating a transition from a passage permission signal to the stop signal as well as the stop signal.

Desired in this technical field in this regard is a traveling control device with which tracking control can be executed in view of a transition signal of a traffic signal ahead.

A traveling control device according to an aspect of the present disclosure is a traveling control device that is configured to execute tracking control of a host vehicle such that the host vehicle tracks a preceding vehicle. The device includes a traffic signal detection unit configured to detect a traffic signal in front of the host vehicle based on a captured image of a space in front of the host vehicle, a timing determination unit configured to determine whether or not the host vehicle has reached a transition signal determination timing set in advance based on a distance from the host vehicle to the traffic signal, a lighting information acquisition unit configured to acquire lighting information relating to a lighting situation of the traffic signal detected by the traffic signal detection unit, a lighting cycle information acquisition unit configured to acquire lighting cycle information of the traffic signal, a transition signal determination unit configured to determine whether or not the lighting situation of the traffic signal in a traveling lane of the host vehicle is a situation in which a transition signal indicating a transition from a passage permission signal to a stop signal is lit based on the lighting information acquired by the lighting information acquisition unit when the host vehicle reaches the transition signal determination timing and the lighting cycle information acquired by the lighting cycle information acquisition unit, a smooth stop possibility determination unit configured to determine whether or not the host vehicle can be smoothly stopped when the transition signal determination unit determines that the lighting situation of the traffic signal in the traveling lane of the host vehicle is the situation in which the transition signal is lit, and a traveling control unit configured to execute the tracking control of the host vehicle and to smoothly stop the host vehicle by terminating the tracking control of the host vehicle when the smooth stop possibility determination unit determines that the host vehicle can be smoothly stopped.

This traveling control device determines whether or not the transition signal is lit in the traffic signal based on the lighting information relating to the lighting situation of the traffic signal in the traveling lane of the host vehicle and the lighting cycle information of the traffic signal when the host vehicle approaches an intersection that has the traffic signal while tracking the preceding vehicle with the tracking control executed. The stop signal is turned on after the transition signal, and thus this device determines whether or not the host vehicle can be smoothly stopped when the device determines that the transition signal is lit in the traffic signal. When the device determines that the host vehicle can be smoothly stopped, the tracking control of the host vehicle for tracking the preceding vehicle is terminated and the host vehicle is smoothly stopped even when the preceding vehicle passes through the intersection. Accordingly, this device is capable of executing the tracking control in view of the transition signal of the traffic signal ahead.

In the traveling control device according to the aspect of the present disclosure, when the lighting information acquisition unit acquires the lighting information of the traffic signal before the host vehicle reaches the transition signal determination timing and the lighting information acquisition unit does not acquire the lighting information of the traffic signal when the host vehicle reaches the transition signal determination timing, the transition signal determination unit may be configured to determine whether or not the lighting situation of the traffic signal in the traveling lane of the host vehicle at a time when the host vehicle reaches the transition signal determination timing is the situation in which the transition signal is lit based on the lighting information relating to the lighting situation acquired by the lighting information acquisition unit before the host vehicle reaches the transition signal determination timing and the lighting cycle information acquired by the lighting cycle information acquisition unit. According to the above, this device is capable of determining whether or not the transition signal is lit in the traffic signal, even when the lighting information relating to the lighting situation of the traffic signal is not acquired, when a determination that the transition signal is lit is already made. Accordingly, this device is capable of executing the tracking control in view of the transition signal of the traffic signal ahead even when the lighting information relating to the lighting situation of the traffic signal cannot be acquired.

According to the aspect of the present disclosure, the tracking control can be executed in view of the transition signal of the traffic signal ahead.

### BRIEF DESCRIPTION OF THE DRAWINGS

FIG. 1 is a block diagram illustrating a traveling control device according to this example.

FIG. 2 is a diagram illustrating a captured image including a traffic signal in front of a host vehicle.

FIG. 3 is a flowchart illustrating processing according to first transition signal determination control.

FIG. 4 is a diagram illustrating a captured image not including the traffic signal in front of the host vehicle.

FIG. 5 is a flowchart illustrating processing according to second transition signal determination control.

### DETAILED DESCRIPTION

Hereinafter, an illustrative example will be described with reference to accompanying drawings.

[Configuration of Traveling Control Device]

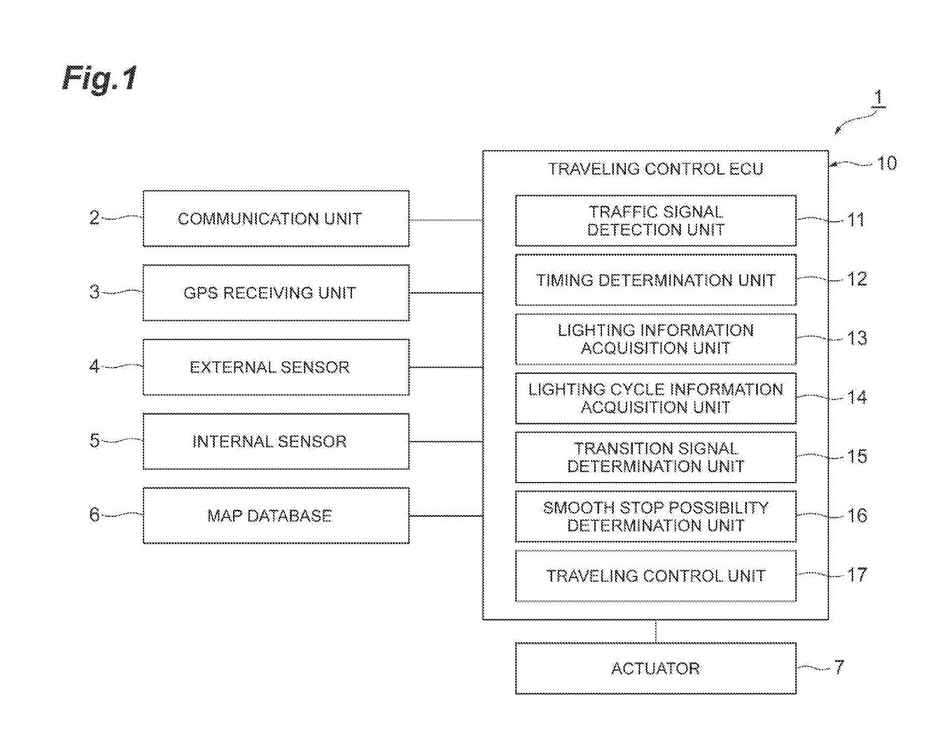

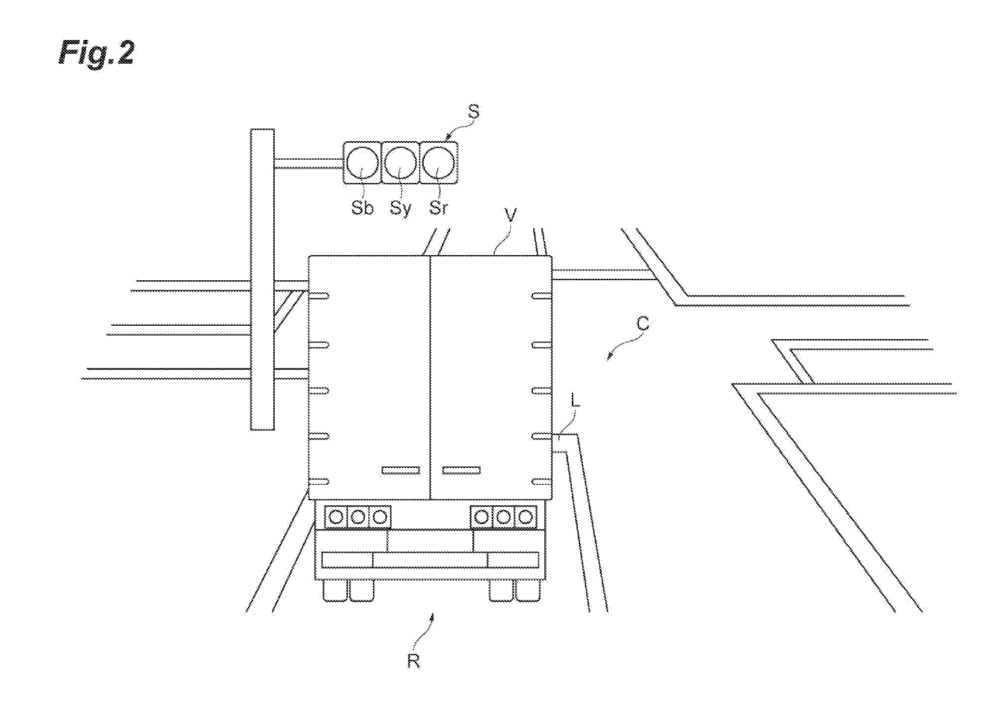

FIG. 1 is a block diagram illustrating a traveling control device 1 according to this example. FIG. 2 is a diagram illustrating a captured image including a traffic signal S in front of a host vehicle. As illustrated in FIGS. 1 and 2, the traveling control device 1 is mounted in the host vehicle such as a passenger car. The traveling control device 1 is a device capable of executing tracking control of the host vehicle such that the host vehicle tracks a preceding vehicle V and executing traveling control in accordance with the lighting situation of the traffic signal S ahead. Here, the host vehicle travels on a double-lane road toward an intersection C that is a crossroads while tracking the preceding vehicle V with the tracking control executed. In a traveling lane R of the host vehicle, a stop line L is marked in front of the intersection C.

The “tracking control” is control for allowing the host vehicle to travel to track the preceding vehicle V when the preceding vehicle V is present in front of the host vehicle. During the tracking control, a speed of the host vehicle is adjusted in accordance with the inter-vehicle distance to the preceding vehicle V. The “lighting situation of the traffic signal” is the situation of, for instance, a light color lit in the traffic signal. The lighting situation of the traffic signal includes situations in which a passage permission signal permitting vehicle passage through the intersection, a stop signal not permitting vehicle passage through the intersection, and a transition signal indicating a transition from the passage permission signal to the stop signal are lit. In other words, the “transition signal” is the lighting situation of the traffic signal turned on immediately after the passage permission signal and immediately before the stop signal. In the following description, the lighting situation of the traffic signal is the situation of, for instance, the light color of the traffic signal in the traveling lane R of the host vehicle. For instance, the traffic signal S in FIG. 2 is disposed over the double-lane road and provided only with a blue signal Sb, a yellow signal Sy, and a red signal Sr. In the traveling lane R of the host vehicle, the blue signal Sb corresponds to the passage permission signal, the yellow signal Sy corresponds to the transition signal, and the red signal Sr corresponds to the stop signal.

The traveling control device 1 is provided with a traveling control electronic control unit [ECU] 10 comprehensively controlling the device. The traveling control ECU 10 is an electronic control unit that has a central processing unit [CPU], a read only memory [ROM], a random access memory [RAM], a controller area network [CAN] communication circuit, and the like. The traveling control ECU 10 realizes each function by, for instance, loading a program stored in the ROM into the RAM and executing the program loaded into the RAM with the CPU. A plurality of ECUs may constitute the traveling control ECU 10 as well. Some of the functions of the traveling control ECU 10 may be executed on a server capable of communicating with the host vehicle.

A communication unit 2, a global positioning system [GPS] receiving unit 3, an external sensor 4, an internal sensor 5, a map database 6, and an actuator 7 are connected to the traveling control ECU 10.

The communication unit 2 performs communication with a lighting cycle information server storing the lighting cycle information of each traffic signal via a wireless network (such as the Internet and a vehicle information and communication system [VICS] (registered trademark)). The communication unit 2 transmits traffic signal identification information (described in detail later) for identifying the traffic signal S in front of the host vehicle to the lighting cycle information server. The communication unit 2 receives the lighting cycle information of the traffic signal S corresponding to the transmitted traffic signal identification information from the lighting cycle information server. The “lighting cycle information” is lighting cycle-related information regarding the order in which the light colors of the traffic signal and so on change and the duration of each light color. The communication unit 2 outputs the received lighting cycle information to the traveling control ECU 10.

The GPS receiving unit 3 acquires positional information indicating the position of the host vehicle by receiving signals from at least three GPS satellites. The positional information includes, for instance, latitude and longitude. The GPS receiving unit 3 outputs the measured positional information on the host vehicle to the traveling control ECU 10. Other means capable of identifying the latitude and the longitude at which the host vehicle is present may be used instead of the GPS receiving unit 3.

The external sensor 4 is detection equipment detecting a situation around the host vehicle. The external sensor 4 includes a camera acquiring a captured image of the space in front of the host vehicle and a radar sensor acquiring the external situation behind the host vehicle. The camera is disposed on, for instance, the back side of the windshield of the host vehicle. The camera may be a monocular camera or may be a stereo camera. The stereo camera has two imaging units that are placed to reproduce a binocular disparity. Information in the depth direction of the captured image (distance information) is also included in the imaging information of the stereo camera. The camera transmits imaging information relating to the captured image to the traveling control ECU 10.

The radar sensor is detection equipment detecting obstacles around the host vehicle by using radio waves (such as millimeter waves) or light. The radar sensor includes, for instance, at least one of a millimeter wave radar device and a light detection and ranging [LIDAR]device. The radar sensor detects the obstacles such as a following vehicle by transmitting the radio waves or the light to the surroundings of the host vehicle and receiving the radio waves or the light reflected by the obstacles. The radar sensor transmits detected obstacle information to the traveling control ECU 10.

The internal sensor 5 is detection equipment detecting the traveling state of the host vehicle. The internal sensor 5 includes a vehicle speed sensor, an acceleration sensor, and a yaw rate sensor. The vehicle speed sensor is a detector that detects the speed of the host vehicle. A vehicle wheel speed sensor that is disposed with respect to a vehicle wheel of the host vehicle, a drive shaft rotating integrally with the vehicle wheel, or the like and detects the rotation speed of the vehicle wheel is used as the vehicle speed sensor.

The acceleration sensor is a detector that detects the acceleration of the host vehicle. The acceleration sensor may include a longitudinal acceleration sensor detecting the acceleration of the host vehicle in a longitudinal direction and a lateral acceleration sensor detecting the acceleration of the host vehicle in a left-right direction. The yaw rate sensor is a detector that detects the yaw rate (rotation angular velocity) around the vertical axis of the center of gravity of the host vehicle. A gyro sensor or the like is used as the yaw rate sensor.

The map database 6 is a database in which map information is stored. The map database 6 is formed within, for instance, a hard disk drive [HDD] that is mounted in the host vehicle. The map information includes, for instance, positional information regarding roads, road shape information (such as curves, types of linear sections and curvatures of curves), road width information, road height information, positional information regarding intersections, positional information regarding junctions and branch points, and positional information regarding buildings. The map information includes positional information regarding traffic signals and the traffic signal identification information for identifying each traffic signal. The traffic signal identification information may be, for instance, information relating to the latitude and the longitude at which the traffic signal is present or an identification [ID] number assigned to each traffic signal. The map information may also include road markings such as lane boundaries and stop lines. The map database 6 may be formed in a computer in a facility such as a management center capable of communicating with the host vehicle.

The actuator 7 is a device that is used for host vehicle control. The actuator 7 includes at least a throttle actuator and a brake actuator. In addition, the actuator 7 may include a steering actuator.

The throttle actuator controls the drive force of the host vehicle by controlling the amount of air supply to an engine (throttle opening degree) in accordance with a control signal from the traveling control ECU 10. When the host vehicle is a hybrid vehicle, the drive force of the host vehicle is controlled by a control signal from the traveling control ECU 10 being input to a motor as a power source as well as by means of the amount of air supply to an engine. When the host vehicle is an electric vehicle, the drive force of the host vehicle is controlled by a control signal from the traveling control ECU 10 being input to a motor as a power source (motor functioning as an engine). The motors as a power source in these cases constitute the actuator 7.

The brake actuator controls a brake system in accordance with a control signal from the traveling control ECU 10 and controls a braking force given to the vehicle wheel of the host vehicle. A hydraulic brake system or the like can be used as the brake system. The steering actuator controls, in accordance with a control signal from the traveling control ECU 10, driving of an assist motor that controls a steering torque in an electric power steering system. In this manner, the steering actuator controls the steering torque of the host vehicle.

The functional configuration of the traveling control ECU 10 will be described below. The traveling control ECU 10 has a traffic signal detection unit 11, a timing determination unit 12, a lighting information acquisition unit 13, a lighting cycle information acquisition unit 14, a transition signal determination unit 15, a smooth stop possibility determination unit 16, and a traveling control unit 17. Some of the functions of the traveling control ECU 10 may be executed on the computer in the facility such as the management center capable of communicating with the host vehicle or may be executed on a portable information terminal capable of communicating with the host vehicle.

The traffic signal detection unit 11 detects the traffic signal S in front of the host vehicle based on the captured image of the space in front of the host vehicle. The traffic signal detection unit 11 acquires the imaging information relating to the captured image of the space in front of the host vehicle captured by the camera of the external sensor 4 and detects the traffic signal S included in the captured image based on the imaging information. When the traffic signal S is detected in the captured image, the traffic signal detection unit 11 acquires information relating to a display position of the traffic signal S on the captured image. The traffic signal detection unit 11 detects the traffic signal S at all times (at predetermined time intervals) regardless of the positional relationship between the host vehicle and the traffic signal S. For instance, the traffic signal detection unit 11 detects the traffic signal by template matching using the color information of the captured image (such as luminance) and/or the shape of the image (such as use of the Hough transform).

The timing determination unit 12 determines whether or not the host vehicle has reached a transition signal determination timing set in advance based on the distance from the host vehicle to the traffic signal. The “transition signal determination timing” means the timing at which it should be determined whether or not the lighting situation of the traffic signal S in the traveling lane R of the host vehicle is a transition signal-lit situation in front of the intersection C that has the traffic signal S. The transition signal determination timing is set in advance to the timing when the host vehicle is positioned in the traveling lane R relatively close to the intersection C. The transition signal determination timing may also be set as the distance from the host vehicle to the traffic signal S. In this case, the transition signal determination timing may be set to the timing when the distance from the host vehicle to the traffic signal S is 20 m, 50 m, 100 m, or the like. Alternatively, the transition signal determination timing may be set as the time required to reach the traffic signal S (time required for the host vehicle to travel up to the traffic signal S), which is calculated based on the distance from the host vehicle to the traffic signal S and the speed of the host vehicle. In this case, the transition signal determination timing may be set to the timing when the time required to reach the traffic signal S is two seconds, five seconds, 10 seconds, or the like.

The lighting information acquisition unit 13 acquires lighting information relating to the lighting situation of the traffic signal S detected by the traffic signal detection unit 11. For instance, the lighting information acquisition unit 13 discerns the lighting situation of the traffic signal S in the traveling lane R of the host vehicle based on the color information of the captured image acquired when the traffic signal S is detected by the traffic signal detection unit 11 and acquires the lighting information relating to the lighting situation. The lighting information acquisition unit 13 stores the acquired lighting information in association with information relating to the timing when the lighting information is acquired.

The lighting cycle information acquisition unit 14 acquires the lighting cycle information of the traffic signal S. The lighting cycle information acquisition unit 14 acquires the positional relationship between the host vehicle and each traffic signal S based on the positional information of the host vehicle acquired by the GPS receiving unit 3 and the positional information of each traffic signal S included in the map information stored in the map database 6. In addition, the lighting cycle information acquisition unit 14 associates the traffic signal S detected by the traffic signal detection unit 11 and the traffic signal S included in the map information stored in the map database 6 with each other based on the acquired positional relationship between the host vehicle and each traffic signal S and the display position of the traffic signal S on the captured image detected in the captured image of the camera by the traffic signal detection unit 11.

Then, the lighting cycle information acquisition unit 14 acquires the traffic signal identification information identifying the traffic signal S from the map information stored in the map database 6. The lighting cycle information acquisition unit 14 transmits the acquired traffic signal identification information to the lighting cycle information server and receives the lighting cycle information of the traffic signal S corresponding to the traffic signal identification information from the lighting cycle information server via the communication unit 2. In this manner, the lighting cycle information acquisition unit 14 acquires the lighting cycle information of the traffic signal S detected by the traffic signal detection unit 1I.

The transition signal determination unit 15 determines whether or not the lighting situation of the traffic signal S in the traveling lane R of the host vehicle is the transition signal-lit situation (that is, whether or not the transition signal is lit in the traveling lane R of the host vehicle) based on the lighting information acquired by the lighting information acquisition unit 13 when the host vehicle reaches the transition signal determination timing and the lighting cycle information acquired by the lighting cycle information acquisition unit 14.

For instance, the lighting cycle of the traffic signal S in FIG. 2 is a cycle in which the “blue signal Sb”, the “yellow signal Sy”, and the “red signal Sr” are turned on at predetermined time intervals in this order. Here, the lighting cycle information relating to the lighting cycle is acquired by the lighting cycle information acquisition unit 14. When the lighting information acquisition unit 13 acquires the lighting information of the blue signal Sb or the red signal Sr being lit in this case, the transition signal determination unit 15 determines that the lighting situation of the traffic signal S in the traveling lane R of the host vehicle is not the transition signal-lit situation (that is, the transition signal is not lit in the traveling lane R of the host vehicle). When the lighting information acquisition unit 13 acquires the lighting information of the yellow signal Sy being lit in this case, the transition signal determination unit 15 determines that the lighting situation of the traffic signal in the traveling lane R of the host vehicle is the transition signal-lit situation (that is, the transition signal is lit in the traveling lane R of the host vehicle).

The smooth stop possibility determination unit 16 determines whether or not the host vehicle can be smoothly stopped when the transition signal determination unit 15 determines that the lighting situation of the traffic signal S in the traveling lane R of the host vehicle is the transition signal-lit situation (that is, the transition signal is lit in the traveling lane R of the host vehicle). The “smooth stop” means stopping safely without passing through the intersection C that has the traffic signal.

As a specific instance, the smooth stop means the host vehicle being decelerated at or below a deceleration set in advance and stopped in front of the stop line L without colliding with a following vehicle. In this case, the smooth stop possibility determination unit 16 acquires the imaging information relating to the captured image of the space in front of the host vehicle captured by the camera of the external sensor 4 and detects a stop line L included in the captured image. For instance, the smooth stop possibility determination unit 16 detects the stop line L by template matching using the color information of the captured image (such as luminance) and/or the shape of the image (such as use of the Hough transform). Then, the smooth stop possibility determination unit 16 acquires the distance from the host vehicle to the stop line L based on the captured image. In addition, the smooth stop possibility determination unit 16 acquires the speed of the host vehicle detected by the vehicle speed sensor of the internal sensor 5. For instance, the smooth stop possibility determination unit 16 determines whether or not the host vehicle can be decelerated at or below the deceleration set in advance and stopped in front of the stop line L based on the distance from the host vehicle to the stop line L and the speed of the host vehicle.

In addition, the smooth stop possibility determination unit 16 detects the inter-vehicle distance between the host vehicle and the following vehicle based on the external situation behind the host vehicle acquired by the radar sensor of the external sensor 4. For instance, the smooth stop possibility determination unit 16 determines whether or not the host vehicle can be stopped without colliding with the following vehicle based on the inter-vehicle distance between the host vehicle and the following vehicle, the speed of the host vehicle, and the deceleration of the host vehicle when the host vehicle stops in front of the stop line L.

The traveling control unit 17 executes the tracking control of the host vehicle such that the host vehicle tracks the preceding vehicle V. In addition, the traveling control unit 17 terminates the tracking control of the host vehicle and smoothly stops the host vehicle when the smooth stop possibility determination unit 16 determines that the host vehicle can be smoothly stopped. The traveling control unit 17 executes the tracking control and the smooth stop of the host vehicle by transmitting a control signal to the actuator 7.

[First Transition Signal Determination Control]

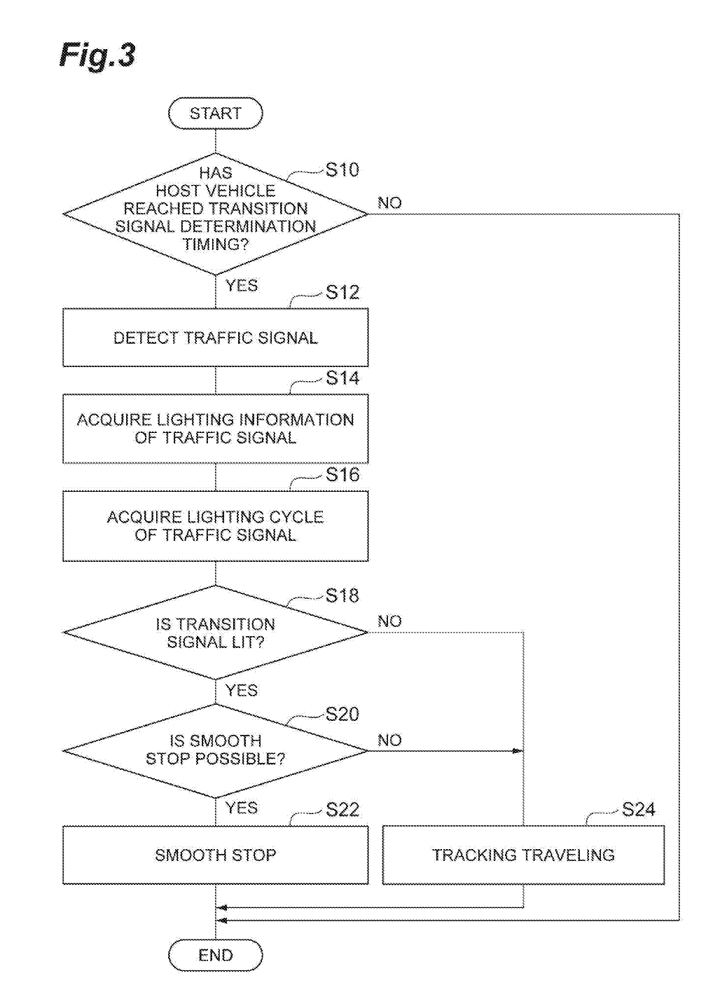

Control (first transition signal determination control) executed by the traveling control device 1 according to this example will be described below. FIG. 3 is a flowchart illustrating processing according to the first transition signal determination control. The flowchart in FIG. 3 is executed when the traveling control unit 17 executes the tracking control of the host vehicle such that the host vehicle tracks the preceding vehicle V.

As illustrated in FIG. 3, in Step S10, the timing determination unit 12 of the traveling control device 1 according to this example determines whether or not the host vehicle has reached the transition signal determination timing. The traveling control device 1 proceeds to Step S12 when the timing determination unit 12 determines that the host vehicle has reached the transition signal determination timing (Step S10: YES). The traveling control device 1 terminates this processing when the timing determination unit 12 does not determine that the host vehicle has reached the transition signal determination timing (Step S10: NO). Subsequently, the traveling control device 1 repeats the processing from Step S10.

In Step S12, the traffic signal detection unit 11 of the traveling control device 1 detects the traffic signal S in front of the host vehicle based on the captured image of the space in front of the host vehicle captured by the camera of the external sensor 4. The traveling control device 1 proceeds to Step S14 once the traffic signal S in front of the host vehicle is detected.

In Step S14, the lighting information acquisition unit 13 of the traveling control device 1 acquires the lighting information relating to the lighting situation of the traffic signal S detected by the traffic signal detection unit 11. The lighting information acquisition unit 13 stores the acquired lighting information in association with the information relating to the timing when the lighting information is acquired. Subsequently, the traveling control device 1 proceeds to Step S16.

In Step S16, the lighting cycle information acquisition unit 14 of the traveling control device 1 acquires the lighting cycle information of the traffic signal S detected by the traffic signal detection unit 11. Specifically, the lighting cycle information acquisition unit 14 associates the traffic signal S detected by the traffic signal detection unit 11 and the traffic signal S included in the map information with each other based on the positional relationship between the host vehicle and each traffic signal S acquired based on the positional information of the host vehicle and the positional information of each traffic signal S included in the map information stored in the map database 6 and the display position of the traffic signal S on the captured image. Then, the lighting cycle information acquisition unit 14 acquires the traffic signal identification information identifying the traffic signal S from the map information. The lighting cycle information acquisition unit 14 transmits the acquired traffic signal identification information to the lighting cycle information server and receives the lighting cycle information of the traffic signal S corresponding to the traffic signal identification information from the lighting cycle information server. Subsequently, the traveling control device 1 proceeds to Step S18.

In Step S18, the transition signal determination unit 15 of the traveling control device 1 determines whether or not the lighting situation of the traffic signal S in the traveling lane R of the host vehicle is the transition signal-lit situation (that is, whether or not the transition signal is lit in the traveling lane R of the host vehicle). The transition signal determination unit 15 determines whether or not the lighting situation of the traffic signal S in the traveling lane R of the host vehicle is the transition signal-lit situation based on the lighting information acquired by the lighting information acquisition unit 13 and the lighting cycle information acquired by the lighting cycle information acquisition unit 14. The traveling control device 1 proceeds to Step S20 when the transition signal determination unit 15 determines that the lighting situation of the traffic signal S in the traveling lane R of the host vehicle is the transition signal-lit situation (Step S18: YES). The traveling control device 1 proceeds to Step S24 when the transition signal determination unit 15 determines that the lighting situation of the traffic signal S in the traveling lane R of the host vehicle is not the transition signal-lit situation (Step S18: NO).

In Step S20, the smooth stop possibility determination unit 16 of the traveling control device 1 determines whether or not the host vehicle can be smoothly stopped. The traveling control device 1 proceeds to Step S22 when the smooth stop possibility determination unit 16 determines that the host vehicle can be smoothly stopped (Step S20: YES). The traveling control device 1 proceeds to Step S24 when the smooth stop possibility determination unit 16 determines that the host vehicle cannot be smoothly stopped (Step S20: NO).

In Step S22, the traveling control unit 17 of the traveling control device 1 smoothly stops the host vehicle by terminating the tracking control of the host vehicle. The traveling control unit 17 executes the smooth stop of the host vehicle by transmitting the control signal to the actuator 7. The traveling control device 1 terminates this processing once the host vehicle is smoothly stopped. Subsequently, the traveling control device 1 repeats the processing from Step S10 when the tracking control of the host vehicle is resumed by the traveling control unit 17.

The traveling control unit 17 of the traveling control device 1 continues to execute the tracking control of the host vehicle in Step S24 before this processing is terminated. Subsequently, the traveling control device 1 repeats the processing from Step S10.

As described above, the traveling control device 1 according to this example determines whether or not the transition signal is lit in the traffic signal S based on the lighting information relating to the lighting situation of the traffic signal S in the traveling lane R of the host vehicle and the lighting cycle information of the traffic signal S when the host vehicle approaches the intersection C that has the traffic signal S while tracking the preceding vehicle V with the tracking control executed. The stop signal is turned on after the transition signal, and thus the traveling control device 1 determines whether or not the host vehicle can be smoothly stopped when the traveling control device 1 determines that the transition signal is lit in the traffic signal S. When the traveling control device 1 determines that the host vehicle can be smoothly stopped, the tracking control of the host vehicle for tracking the preceding vehicle V is terminated and the host vehicle is smoothly stopped even when the preceding vehicle V passes through the intersection. Accordingly, the traveling control device 1 is capable of executing the tracking control in view of the transition signal of the traffic signal S ahead.

### Modification Example

The above-described example can be implemented in various forms changed and improved in various ways based on the knowledge of those skilled in the art.

[Second Transition Signal Determination Control]

For instance, the traveling control device 1 according to a modification example may be capable of executing second transition signal determination control instead of the first transition signal determination control. The second transition signal determination control executed by the traveling control device 1 according to the modification example will be described below.

When the lighting information acquisition unit 13 acquires the lighting information of the traffic signal S before the host vehicle reaches the transition signal determination timing and the lighting information acquisition unit 13 does not acquire the lighting information of the traffic signal S when the host vehicle reaches the transition signal determination timing in the traveling control device 1 capable of executing the second transition signal determination control, the transition signal determination unit 15 determines (estimates) whether or not the lighting situation of the traffic signal S in the traveling lane R of the host vehicle at a time when the host vehicle reaches the transition signal determination timing is the transition signal-lit situation based on the lighting information relating to the lighting situation (the lighting situation-related lighting information) acquired by the lighting information acquisition unit 13 before the host vehicle reaches the transition signal determination timing and the lighting cycle information acquired by the lighting cycle information acquisition unit 14. Preferably, the point in time corresponding to “before the host vehicle reaches the transition signal determination timing” is a point in time when it is possible to accurately measure an elapsed time from the point in time to the time when the host vehicle reaches the transition signal determination timing.

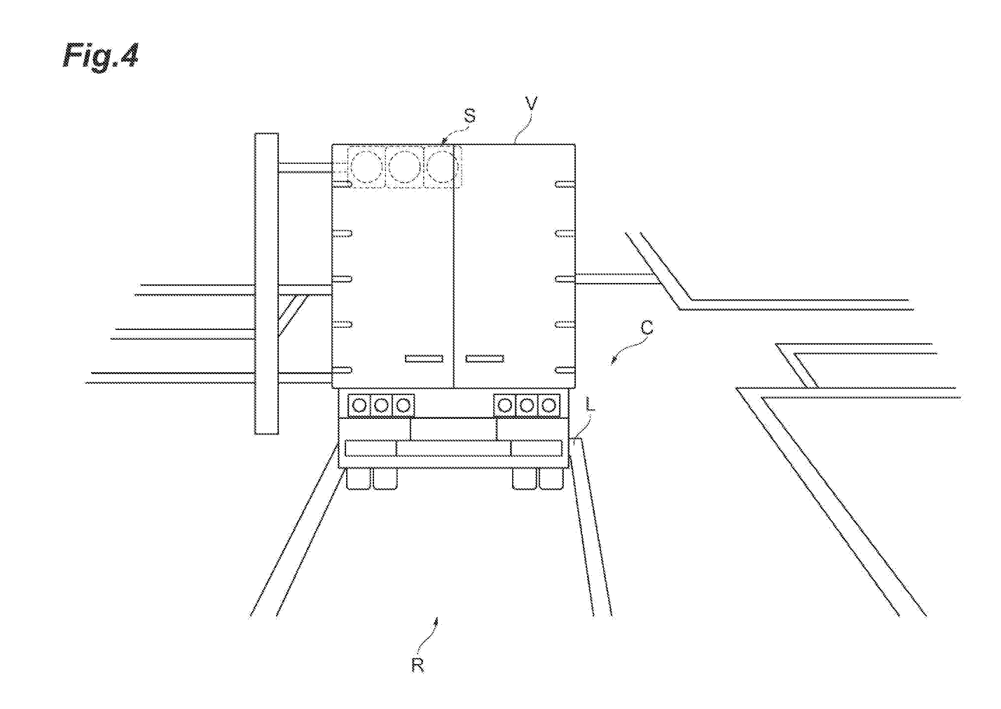

FIG. 4 is a diagram illustrating a captured image not including the traffic signal S in front of the host vehicle. Illustrated in FIG. 4 is a state where the traffic signal S is hidden by the tall preceding vehicle V and not reflected in the captured image. Here, as an instance, the lighting cycle of the traffic signal S in FIGS. 2 and 4 is a cycle in which the “90-second blue signal Sb”, the “three-second yellow signal Sy”, and the “90-second red signal Sr” are turned on in this order. Here, the lighting cycle information relating to the lighting cycle is acquired by the lighting cycle information acquisition unit 14. In this case, for instance, it is assumed that the lighting information of changing from the red signal Sr to the blue signal Sb is acquired by the lighting information acquisition unit 13 30 seconds before the host vehicle reaches the transition signal determination timing. In this case, the transition signal determination unit 15 determines that the light color of the traffic signal S at a time when the host vehicle reaches the transition signal determination timing is the “blue signal” and the lighting situation of the traffic signal S in the traveling lane R of the host vehicle is not the transition signal-lit situation even when the lighting information of the traffic signal S is not acquired by the lighting information acquisition unit 13 (refer to FIG. 4) when the host vehicle reaches the transition signal determination timing (that is, the point in time 30 seconds after the point in time when the lighting information is acquired by the lighting information acquisition unit 13).

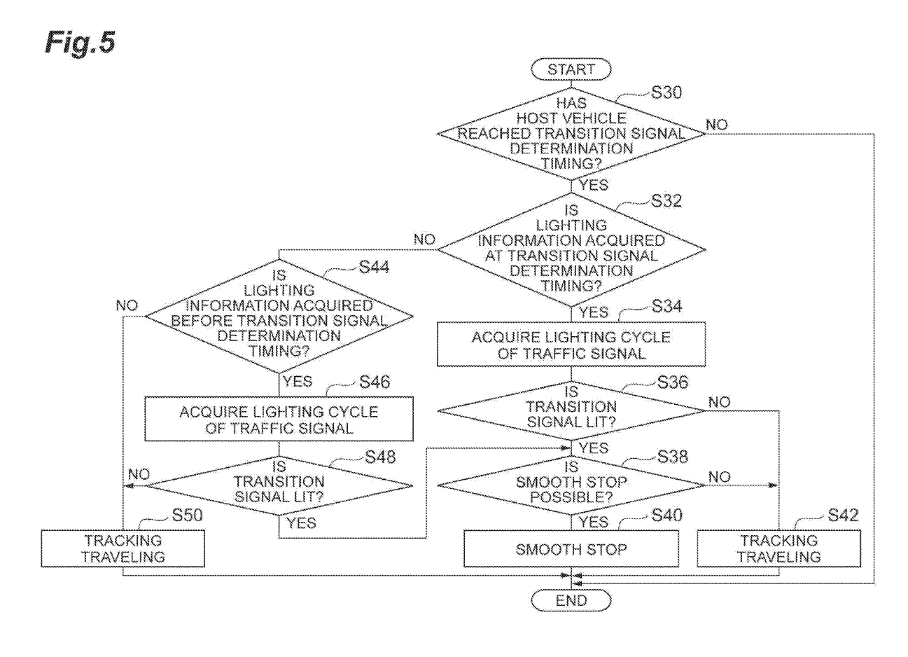

FIG. 5 is a flowchart illustrating processing according to the second transition signal determination control. The flowchart in FIG. 5 is executed when the traveling control unit 17 executes the tracking control of the host vehicle such that the host vehicle tracks the preceding vehicle V.

As illustrated in FIG. 5, in Step S30, the timing determination unit 12 of the traveling control device 1 according to the modification example determines whether or not the host vehicle has reached the transition signal determination timing. The traveling control device 1 proceeds to Step S32 when the timing determination unit 12 determines that the host vehicle has reached the transition signal determination timing (Step S30: YES). The traveling control device 1 terminates this processing when the timing determination unit 12 does not determine that the host vehicle has reached the transition signal determination timing (Step S30: NO). Subsequently, the traveling control device 1 repeats the processing from Step S30.

In Step S32, the traveling control device 1 determines whether or not the traffic signal S in front of the host vehicle is detected by the traffic signal detection unit 11 and the lighting information relating to the lighting situation of the traffic signal S is acquired by the lighting information acquisition unit 13 when the host vehicle reaches the transition signal determination timing (that is, at the transition signal determination timing). The traveling control device 1 proceeds to Step S34 when the traveling control device 1 determines that the lighting information relating to the lighting situation of the traffic signal S is acquired by the lighting information acquisition unit 13 when the host vehicle reaches the transition signal determination timing (Step S32: YES). The traveling control device 1 proceeds to Step S44 when the traveling control device 1 does not determine that the lighting information relating to the lighting situation of the traffic signal S is acquired by the lighting information acquisition unit 13 when the host vehicle reaches the transition signal determination timing (Step S32: NO).

The following Steps S34 to S42 respectively correspond to Steps S16 to S24 of the first transition signal determination control described in FIG. 3. In other words, the traveling control device 1 executes processing similar to Step S16 in Step S34, executes processing similar to Step S18 in Step S36, executes processing similar to Step S20 in Step S38, executes processing similar to Step S22 in Step S40, and executes processing similar to Step S24 in Step S42. Description of Steps S34 to S42 will be omitted here.

In Step S44, the traveling control device 1 determines whether or not the traffic signal S in front of the host vehicle is detected by the traffic signal detection unit 11 and the lighting information relating to the lighting situation of the traffic signal S is acquired by the lighting information acquisition unit 13 before the host vehicle reaches the transition signal determination timing (that is, before the transition signal determination timing). The traveling control device 1 proceeds to Step S46 when the traveling control device 1 determines that the lighting information relating to the lighting situation of the traffic signal S is acquired by the lighting information acquisition unit 13 before the host vehicle reaches the transition signal determination timing (Step S44: YES). The traveling control device 1 proceeds to Step S50 when the traveling control device 1 does not determine that the lighting information relating to the lighting situation of the traffic signal S is acquired by the lighting information acquisition unit 13 before the host vehicle reaches the transition signal determination timing (Step S44: NO).

In Step S46, the lighting cycle information acquisition unit 14 of the traveling control device 1 acquires the lighting cycle information of the traffic signal S detected by the traffic signal detection unit 11. Specifically, in Step S46, the traveling control device 1 receives the lighting cycle information of the traffic signal S from the lighting cycle information server by executing processing similar to Step S16 of the first transition signal determination control described in FIG. 3. Subsequently, the traveling control device 1 proceeds to Step S48.

In Step S48, the transition signal determination unit 15 of the traveling control device 1 determines whether or not the lighting situation of the traffic signal S in the traveling lane R of the host vehicle is the transition signal-lit situation (that is, whether or not the transition signal is lit in the traveling lane R of the host vehicle). The transition signal determination unit 15 determines whether or not the lighting situation of the traffic signal S in the traveling lane R of the host vehicle is the transition signal-lit situation based on the lighting information acquired by the lighting information acquisition unit 13 and the lighting cycle information acquired by the lighting cycle information acquisition unit 14. The traveling control device 1 proceeds to Step S38 when the transition signal determination unit 15 determines that the lighting situation of the traffic signal S in the traveling lane R of the host vehicle is the transition signal-lit situation (Step S48: YES). The traveling control device 1 proceeds to Step S50 when the transition signal determination unit 15 determines that the lighting situation of the traffic signal S in the traveling lane R of the host vehicle is not the transition signal-lit situation (Step S48: NO).

As described above, in Step S38, the traveling control device 1 executes processing similar to Step S20 of the first transition signal determination control described in FIG. 3. The smooth stop possibility determination unit 16 of the traveling control device 1 determines whether or not the host vehicle can be smoothly stopped. The traveling control device 1 proceeds to Step S40 when the smooth stop possibility determination unit 16 determines that the host vehicle can be smoothly stopped (Step S38: YES). In Step S40, the traveling control unit 17 of the traveling control device 1 smoothly stops the host vehicle by terminating the tracking control of the host vehicle. The traveling control device 1 proceeds to Step S42 when the smooth stop possibility determination unit 16 determines that the host vehicle cannot be smoothly stopped (Step S38: NO). The traveling control unit 17 of the traveling control device 1 continues to execute the tracking control of the host vehicle in Step S42 before this processing is terminated.

The traveling control unit 17 of the traveling control device 1 continues to execute the tracking control of the host vehicle in Step S50 before this processing is terminated. Subsequently, the traveling control device 1 repeats the processing from Step S30.

As described above, when the lighting information acquisition unit 13 acquires the lighting information of the traffic signal S before the host vehicle reaches the transition signal determination timing and the lighting information acquisition unit 13 does not acquire the lighting information of the traffic signal S when the host vehicle reaches the transition signal determination timing in the traveling control device 1 according to the modification example, the transition signal determination unit 15 determines whether or not the lighting situation of the traffic signal S in the traveling lane R of the host vehicle at a time when the host vehicle reaches the transition signal determination timing is the transition signal-lit situation based on the lighting information relating to the lighting situation (the lighting situation-related lighting information) acquired by the lighting information acquisition unit 13 before the host vehicle reaches the transition signal determination timing and the lighting cycle information acquired by the lighting cycle information acquisition unit 14. As a result, the traveling control device 1 according to the modification example is capable of determining whether or not the transition signal is lit in the traffic signal S, even when the lighting information relating to the lighting situation of the traffic signal S is not acquired, when a determination that the transition signal is lit is already made. Accordingly, the traveling control device 1 according to the modification example is capable of executing the tracking control in view of the transition signal of the traffic signal S ahead even when the lighting information relating to the lighting situation of the traffic signal S cannot be acquired.

### Another Modification Example

In addition, the smooth stop may also mean the host vehicle stopping in front of the stop line L without colliding with the following vehicle and without colliding with the preceding vehicle V through deceleration at or below a deceleration set in advance.

In addition, the smooth stop possibility determination unit 16 may determine whether or not the host vehicle can be smoothly stopped by digitizing the risk of host vehicle stop and the risk of intersection passage and comparing each risk in the current situation to a threshold set in advance. The risk of stop may be calculated based on, for instance, the inter-vehicle distance to the following vehicle and the relative speed with respect to the following vehicle. The risk of intersection passage may be calculated based on, for instance, the speed of the preceding vehicle V, the speed of the host vehicle, and the distance between the host vehicle and the stop line L.

For instance, the smooth stop possibility determination unit 16 may determine that the host vehicle can be smoothly stopped when the numerical value of the stop risk is less than a first threshold set in advance. In addition, the smooth stop possibility determination unit 16 may determine that the host vehicle cannot be smoothly stopped when the numerical value of the stop risk is equal to or greater than the first threshold and the numerical value of the passage risk is less than a second threshold set in advance. The smooth stop possibility determination unit 16 may determine that an emergency stop of the host vehicle is needed when the numerical value of the stop risk is equal to or greater than the first threshold and the numerical value of the intersection passage risk is equal to or greater than the second threshold.

In addition, when the traffic signal S is imaged by the camera of the external sensor 4 over one or more lighting cycles and the lighting information acquisition unit 13 continues to acquire the lighting information relating to the lighting situation of the traffic signal over the one or more lighting cycles, the lighting cycle information acquisition unit 14 may acquire the lighting cycle information of the traffic signal S based on the acquired lighting information. In this manner, the traveling control device 1 is capable of acquiring the lighting cycle information of the traffic signal S without communicating with the external lighting cycle information server or the like.

In addition, the situation in which the lighting information acquisition unit 13 is incapable of acquiring the lighting information relating to the lighting situation of the traffic signal S is not limited to the situation in which the traffic signal S is hidden by the preceding vehicle V and not reflected in the captured image as illustrated in FIG. 4 and may also be, for instance, a situation in which the traffic signal S is not reflected in the captured image due to backlight (state where the sunlight comes into the vehicle from the front of the vehicle).

In the example described above, the traffic signal S is disposed over the double-lane road and provided only with the blue signal Sb, the yellow signal Sy, and the red signal Sr as illustrated in FIG. 2. However, the traffic signal may be provided with, for instance, an arrow signal permitting intersection passage only in the direction indicated by the arrow in addition to the blue signal Sb, the yellow signal Sy, and the red signal Sr.

For instance, in a traffic signal provided with the arrow signal, the same light color (the light color and the arrow signal that are lit) or the like corresponds or does not correspond to the transition signal depending on the traveling lane of the host vehicle. A traffic signal will be exemplified that is provided with a straight traveling arrow signal permitting intersection passage only in a straight traveling direction and a right turn arrow signal permitting intersection passage only in a right turn direction in addition to the blue signal Sb, the yellow signal Sy, and the red signal Sr. It is assumed that the lighting cycle of the traffic signal is a cycle in which a “first lighting situation in which the red signal and the straight traveling arrow signal are lit”, a “second lighting situation in which the yellow signal is lit”, a “third lighting situation in which the red signal and the right turn arrow signal are lit”, a “fourth lighting situation in which the yellow signal is lit”, and a “fifth lighting situation in which the red signal is lit” are turned on in this order. In other words, the yellow traffic signal is turned on in both the second lighting situation and the fourth lighting situation.

In this case, the first lighting situation corresponds to the stop signal, the third lighting situation corresponds to the passage permission signal, and the fifth lighting situation corresponds to the stop signal for the host vehicle about to turn right at the intersection when the traveling direction (traveling lane R) of the host vehicle is the direction of “turning right at the intersection”. Accordingly, for the host vehicle about to turn right at the intersection, the second lighting situation in which the yellow signal is lit indicates a transition from the stop signal (first lighting situation) to the passage permission signal (third lighting situation), and thus does not correspond to the transition signal. The fourth lighting situation in which the yellow signal is lit, in the meantime, indicates a transition from the passage permission signal (third lighting situation) to the stop signal (fifth lighting situation), and thus corresponds to the transition signal.

In this situation, the traveling control device 1 is incapable of discerning the second lighting situation and the fourth lighting situation from the lighting information acquired by the lighting information acquisition unit 13 when the host vehicle reaches the transition signal determination timing. Accordingly, the traveling control device 1 is incapable of determining whether or not the lighting situation of the traffic signal in the traveling lane R of the host vehicle is the transition signal-lit situation (fourth lighting situation).

In this regard, the traveling control device 1 may determine whether or not the lighting situation of the traffic signal in the traveling lane R of the host vehicle is the transition signal-lit situation (fourth lighting situation) based on the lighting information acquired by the lighting information acquisition unit 13 before the host vehicle reaches the transition signal determination timing, the lighting information acquired by the lighting information acquisition unit 13 when the host vehicle reaches the transition signal determination timing, and the lighting cycle information acquired by the lighting cycle information acquisition unit 14. For instance, a determination is made that the current lighting situation of the traffic signal is the second lighting situation when the “red signal- and straight traveling arrow signal-lit situation (first lighting situation)” is determined immediately before the “yellow signal-lit situation” with the “yellow signal-lit situation (second lighting situation or fourth lighting situation)” determined when the host vehicle reaches the transition signal determination timing. A determination is made that the current lighting situation of the traffic signal is the fourth lighting situation when the “red signal- and right turn arrow signal-lit situation (third lighting situation)” is determined immediately before the “yellow signal-lit situation” with the “yellow signal-lit situation” determined at the transition signal determination timing.

What is claimed is:

1. A traveling control device that is configured to execute tracking control of a host vehicle such that the host vehicle tracks a preceding vehicle, the device comprising:
a traffic signal detection unit configured to detect a traffic signal in front of the host vehicle based on a captured image of a space in front of the host vehicle;
a timing determination unit configured to determine whether or not the host vehicle has reached a transition signal determination timing set in advance based on a distance from the host vehicle to the traffic signal;
a lighting information acquisition unit configured to acquire lighting information relating to a lighting situation of the traffic signal detected by the traffic signal detection unit;
a lighting cycle information acquisition unit configured to acquire lighting cycle information of the traffic signal;
a transition signal determination unit configured to determine whether or not the lighting situation of the traffic signal in a traveling lane of the host vehicle is a situation in which a transition signal indicating a transition from a passage permission signal to a stop signal is lit based on the lighting information acquired by the lighting information acquisition unit when the host vehicle reaches the transition signal determination timing and the lighting cycle information acquired by the lighting cycle information acquisition unit;
a smooth stop possibility determination unit configured to determine whether or not the host vehicle can be smoothly stopped when the transition signal determination unit determines that the lighting situation of the traffic signal in the traveling lane of the host vehicle is the situation in which the transition signal is lit; and
a traveling control unit configured to execute the tracking control of the host vehicle and to smoothly stop the host vehicle by terminating the tracking control of the host vehicle when the smooth stop possibility determination unit determines that the host vehicle can be smoothly stopped.

2. The traveling control device according to claim 1, wherein, when the lighting information acquisition unit acquires the lighting information of the traffic signal before the host vehicle reaches the transition signal determination timing and the lighting information acquisition unit does not acquire the lighting information of the traffic signal when the host vehicle reaches the transition signal determination timing, the transition signal determination unit is configured to determine whether or not the lighting situation of the traffic signal in the traveling lane of the host vehicle at a time when the host vehicle reaches the transition signal determination timing is the situation in which the transition signal is lit based on the lighting information relating to the lighting situation acquired by the lighting information acquisition unit before the host vehicle reaches the transition signal determination timing and the lighting cycle information acquired by the lighting cycle information acquisition unit.
